(19) United States
(12) Patent Application Publication
(10) Pub. No.: US 2024/0028483 A1
(43) Pub. Date: Jan. 25, 2024

(54) CLUSTER AWARE RESTORES

(71) Applicant: Dell Products L.P., Round Rock, TX (US)

(72) Inventors: Sunil Yadav, Bangalore (IN); Shelesh Chopra, Bangalore (IN); Preeti Varma, Bangalore (IN)

(21) Appl. No.: 17/872,655

(22) Filed: Jul. 25, 2022

(51) Int. Cl. G06F 11/14

(52) U.S. Cl. CPC G06F 11/1469; G06F 2201/84

(57) ABSTRACT

One or more embodiments of the invention relates to a method of performing a restore, by either allowing a user or administrator to choose a preferred data node for performing a restoration, or by having a data protection manager or similar component of a system dynamically choses a preferred data node for performing a restoration based on predetermined criteria. Such predetermined criteria may include each data node's load and workload as well as the type of backup that was performed to make the backup of the at least one selected asset. This will allow for more efficient restoration, while avoiding overloading when restoring assets from a backup in a data cluster.

### BACKGROUND

In an enterprise environment, clustering is frequently used. One version of clustering, failover clustering, allows for a plurality of nodes to work together to increase the availability and scalability of the nodes. If a failure occurs in one or more of the nodes, other nodes are able to provide the services of the failed nodes with minimum disruptions to the end users of the node(s). To prevent loss of important data, performing backups and restorations of the assets located on the plurality of nodes or other related computing devices is necessary. However, in a clustering system that includes shared storage, performing a backup and/or restoration becomes increasingly difficult.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows a diagram of a cluster environment in accordance with one or more embodiments of the invention.

FIG. 2A shows a flowchart of a method for performing a data protection event such as a backup and/or restoration in accordance with one or more embodiments of the invention.

FIG. 2B shows a flowchart of a method for performing a restoration of selected asset in accordance with one or more embodiments of the invention.

FIG. 2C shows a flowchart of a method for determining a preferred data node for use in the restoration of the method of FIG. 2B in accordance with one or more embodiments of the invention.

FIG. 3 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regards to any other figure. For brevity, descriptions of these components will not be repeated with regards to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of the figures may be labeled as A to C. As used herein, the aforementioned labeling means that the element may include any number of items and does not require that the element include the same number of elements as any other item labeled as A to C. For example, a data structure may include a first element labeled as A and a second element labeled as C. This labeling convention means that the data structure may include any number of the elements. A second data structure, also labeled as A to C, may also include any number of elements. The number of elements of the first data structure and the number of elements of the second data structure may be the same or different.

In general, embodiments of the invention relate to system and methods for managing data clusters. More specifically, embodiments of the invention relate to a method of performing a restoration from a backup of at least one selected asset located in the data cluster.

Generally, when a restore is triggered, the original data node (also referred to as a node) that performed the backup of the at least one selected asset, performs the restoration. However, in a cluster environment this may not be the best or appropriate node to use. For example, if the backup is from data node one and data node one is no-longer available, this would require a user or administrator to redirect the restore to a different node. Further, with failover, even if data node one is currently active, it may not be the current active node for a selected asset that is to be restored. Further, restoring may result in the data node being overloaded.

One or more embodiments of the invention improves upon the traditional method of performing a restore, by either allowing a user or administrator to choose a preferred data node for performing a restoration, or by having a data protection manager or similar component of a system dynamically chose a preferred data node for performing a restoration based on the predetermined criteria. Such predetermined criteria may include each data node's load and workload as well as the type of backup that was performed to make the backup of the selected asset(s). This will allow for a more efficient restoration while avoiding overloading when restoring assets from a backup in a data cluster.

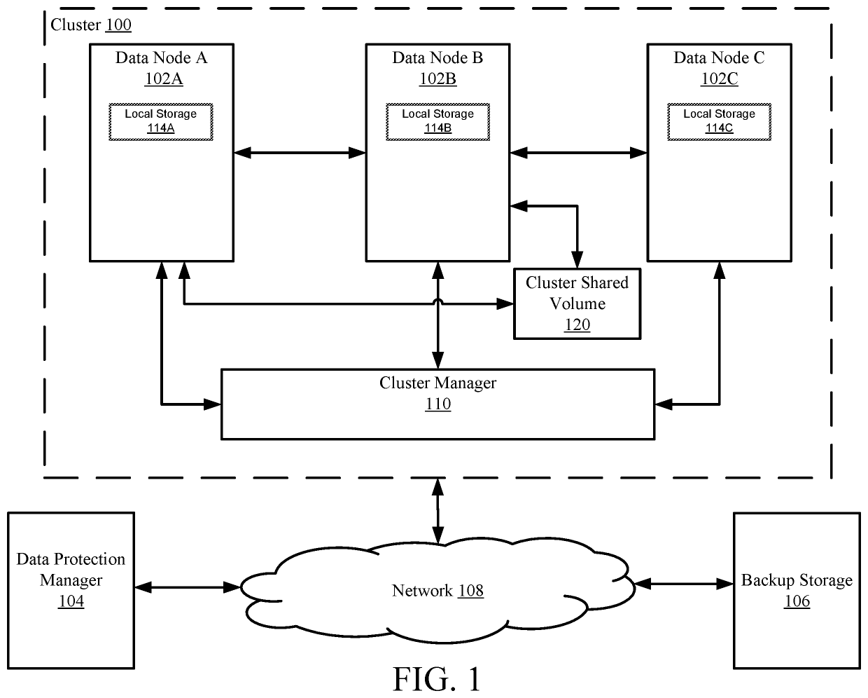

FIG. 1 shows a diagram of a system in accordance with one or more embodiments of the invention. The system may include a data protection manager (104), backup storage (106), and at least one data cluster (100). The system may include any number of data clusters (100) without departing from the invention. For example, the system may include two data clusters (not shown) that communicate through a network (108). The system may include additional, fewer, and/or other components without departing from the invention. Each of the components in the system may be operatively connected via any combination of wireless and/or wired networks (108).

In one or more embodiments of the invention, the data cluster (100) may include a plurality of nodes (e.g., 102A-102C), a cluster manager (110), and at least one cluster shared volume(s) (120). The system may include any number of data nodes (e.g., 102A-102C) without departing from the invention. For example, the system may include two data nodes (102A) and (102B) that communicate through an internal network or by other means. The system may include additional, fewer, and/or other components without departing from the invention. Each of the components of the data cluster may be operatively connected via any combination of wireless and/or wired networks (108).

In one or more embodiments of the invention, the data protection manager (104) includes the functionality to provide data protection services to the data cluster (100). The data protection manager (104) may include the functionality to provide and/or obtain other and/or additional services without departing from the invention. While FIG. 1 shows the data protection manager (104) as a separate component, it can be a part of the cluster manager (110) or located in one or more of the data nodes (e.g., 102A-102C).

To perform the aforementioned data protection services, the data protection manager (104) may include various modules such as a mapping module (not shown). The data protection manager (104) may also include persistent storage (not shown), or it may store data on one or more of the local storage devices (114A-114C) that are associated with the data nodes (e.g., 102A-102C). Alternatively, the data protection manager (104) can store data on the cluster shared volumes (e.g., 120). The data protection manager (104) may include other and/or additional components without departing from the invention. Each of the aforementioned components of the data protection manager (104) is discussed below.

In one or more embodiments of the invention, the data protection manager (104) initiates data protection events such as discovery, backup, and restoration. The data protection manager (104) communicates with the cluster (100) so that the cluster manager (110) or appropriate node (e.g., 102A-102C) can carry out the data protection event.

In one or more embodiments of the invention, the data protection manager (104) may include a user interface that allows a user or administrator to configure or change a data protection event. This may include having a display, display a graphical user interface (GUI) that presents options to a user or administrator that they can select from such as a preferred node to perform the data protection event, or indications of which assets/applications a user or administrator wants to have protected.

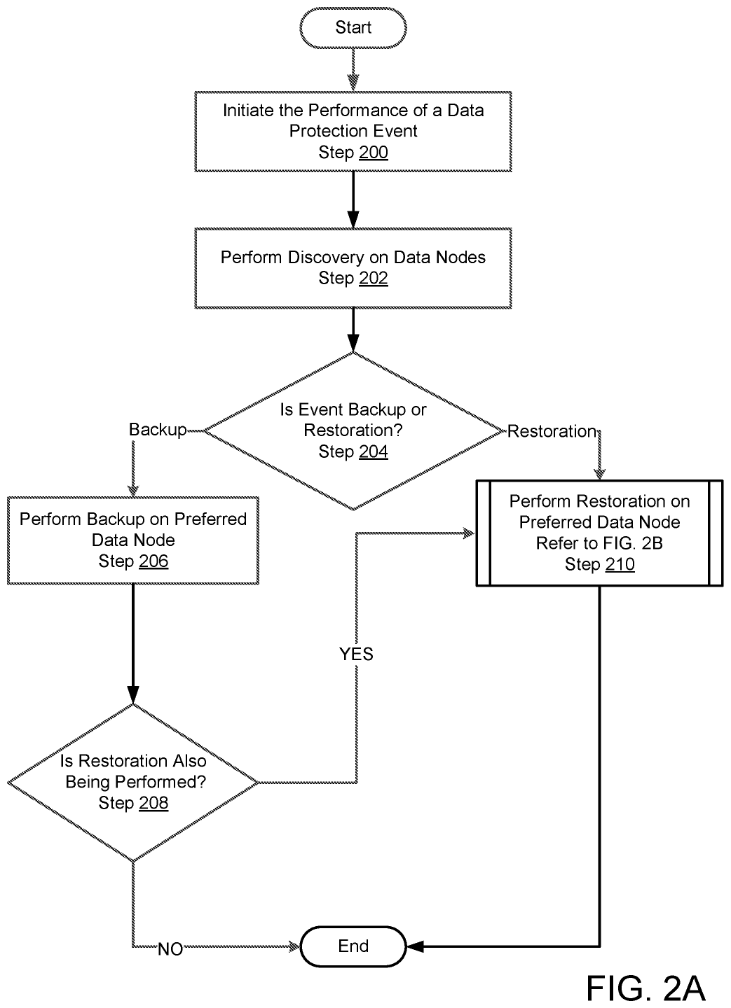

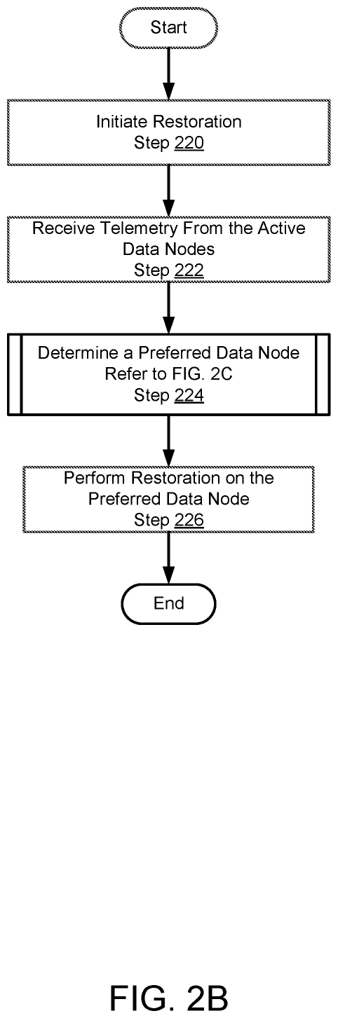

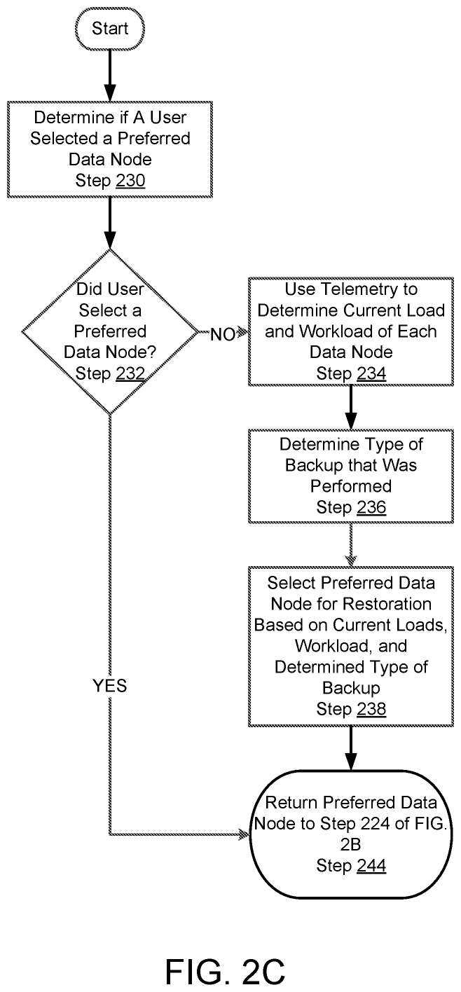

In one or more embodiments of the invention, the data protection manager (104) may determine a preferred data node (e.g., 102A-102C) for performing of data protection such as a restoration on a given asset such as a specific application and its data and/or an entire volume. An example of the method for determining the preferred data node is shown in FIGS. 2B and 2C. The determination of the preferred node may be done during periodic discovery after receiving a request for a data protection event (such as those discussed in more detail below with regards to the methods shown in FIGS. 2A-2C), or at any other configured time as configured by a user, administrator, or system designer/manufacturer.

In one or more embodiments of the invention, the cluster manager (110) may receive a request to perform a data protection event from the data protection manager (e.g., 104), backup storage (e.g., 106), a user or administrator of the cluster (100), or from any other source. Once the cluster manager receives the request, it can direct the appropriate data node, such as the preferred data node obtained in the method of FIG. 2B to perform the backup, or a restoration as described in more detail with regards to the method shown in FIGS. 2A and 2C).

In one or more embodiments of the invention, when a data protection event is initialized, such as a restoration, the data protection manager (104) determines the preferred data node for performing the event. This can include by receiving telemetry from each of the data nodes (e.g., 102A-102C) as well as analyzing any previous backups that have been performed on a selected asset.

The backups are analyzed to determine information which allows the data protection manager (104) to determine which data node (e.g., 102A-102C) is the preferred data node for performing the event. In the case where the event is a restoration, this may include determining which data node (e.g., 102A-102C) originally performed the backup. The protection manager (104) may also analyze the type of backup that was perform, such as, but not limited to, a full, incremental, block-based backup (BBB), or file-based backup (FBB). Each backup type has different requirements and requires different amounts of resources when the backup is restored.

Based on the telemetry, analyzation of the original backup, and other pertinent information such as user/administrator input; the data protection manager (104) can determine a preferred node (e.g., 102A). Once the preferred node is determined, the data manager (104) can signal the preferred data node (e.g., 102A) to perform the data protection event such as perform a restoration. The method, of determining the preferred node (e.g., 102A) and at least performing a restoration with the preferred node (e.g., 102A), in accordance with one or more embodiments of the invention, is described in more detail below with regards to the methods shown in FIGS. 2A-2C.

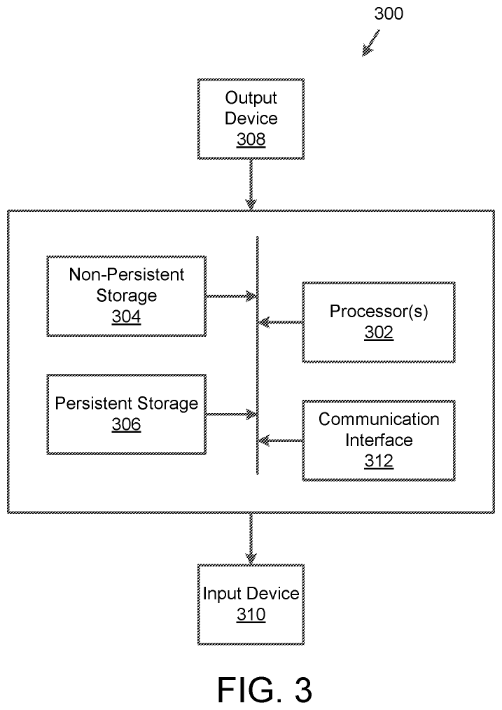

In one or more embodiments of the invention, the data protection manager (104) is implemented as a computing device (see e.g., FIG. 3). The computing device may be, for example, a mobile phone, tablet computer, laptop computer, desktop computer, server, distributed computing system, or cloud resource. The computing device may include one or more processors, memory (e.g., random access memory), and persistent storage (e.g., disk drives, solid state drives, etc.). The computing device may include instructions stored on the persistent storage, that when executed by the processor(s) of the computing device, it will cause the computing device to perform the functionality of the data protection manager (104) as described throughout this application.

In one or more embodiments of the invention, the data protection manager (104) is implemented as a logical device. The logical device may utilize the computing resources of any number of computing devices and thereby provide the functionality of the data protection manager (104) as described throughout this application.

In one or more embodiments of the invention, the data protection manager (104) works with backup storage (106) to store backups and mapping information. Backup storage can comprise of local storage/volumes that are stored in any of the local storage devices (e.g., 114A-114C) or the cluster shared volumes (120). In one or more embodiments of the invention, the backup storage (106) can comprise of storage that is not part of the cluster (100). Backup storage (106) can also comprise of off-site storage including, but not limited to, cloud base storage and long-term storage such as tape drives, depending on the particular needs of the user and/or the system. The backup storage (106) may include one or more processors, memory (e.g., random access memory) and persistent storage (e.g., disk drives, solid state drives, etc.).

In one or more embodiments of the invention, the backup storage (106) includes the functionality to provide backup storage services to the data nodes (e.g., 102A-102C) as discussed above. The backup storage services may include (i) obtaining backups of data generated through the performance of computer implemented services from the data nodes (100), (ii) storing data and metadata associated with the backups in persistent storage of the backup storage (106), and (iii) providing backups to the data nodes (e.g., 102A-102C) for restoration purposes and/or other purposes without departing from the invention. The backup storage services may include the functionality to provide and/or obtain other services without departing from the invention. The backup storage (106) may include any number of backup storages without departing from the invention.

In one or more embodiments of the invention, the backup storage (106) is implemented as a computing device (see e.g., FIG. 3). A computing device may be, for example, a mobile phone, tablet computer, laptop computer, desktop computer, server, distributed computing system, or cloud resource. The computing device may include one or more processors, memory (e.g., random access memory), and persistent storage (e.g., disk drives, solid state drives, etc.). The computing device may include instructions stored on the persistent storage, that when executed by the processor(s) of the computing device it causes the computing device to perform the functionality of a backup storage (106) as described throughout this application.

In one or more embodiments of the invention, the backup storage (106) is implemented as a logical device. The logical device may utilize the computing resources of any number of computing devices and thereby provide the functionality of the backup storage (106) as described throughout this application.

In one or more embodiments of the invention the data protection manager (104) and backup storage (106), communicate with the cluster (100) through a network (108). The network (108) can take any form of network including any combination of wireless and/or wired networks. The network (108) can be a local network (LAN) or a wide area network (WLAN) including the Internet or a private enterprise network that connects more than one location. The network (108) can be any combination of the above networks, other known network, or any combination of network types.

In one or more embodiments of the invention, the network (108) allows the cluster (100) to communicate with other clusters (not shown) and external computing devices such as (but not limited to) a data protection manager (e.g., 104) and backup storage (e.g., 106). The various components of the cluster (100) may also communicate with each other through a network. The network may be a high-speed internal network and/or include part of an external network (108). The data nodes (e.g., 102A-102C), cluster share volume (e.g., 120) and cluster manager (e.g., 110) communicate with each other over the internal network and in one or more embodiments of the invention provide fallback functionality.

A network (e.g., network (108)) may refer to an entire network or any portion thereof (e.g., a logical portion of the devices within a topology of devices). A network may include a data center network, wide area network, local area network, wireless network, cellular phone network, and/or any other suitable network that facilitates the exchange of information from one part of the network to another. A network may be located at a single physical location or be distributed at any number of physical sites. In one or more embodiments, a network may be coupled with or overlap, at least in part, with the Internet.

In one or more embodiments, although shown separately in FIG. 1, the network (108) may include any number of devices within any components (e.g., 100, 104, and 106) of the system, as well as devices external to or between such components of the system. In one or more embodiments, at least a portion of such devices are network devices (not shown). In one or more embodiments, a network device is a device that includes and/or is operatively connected to persistent storage (not shown), memory (e.g., random access memory (RAM)) (not shown), one or more processor(s) (e.g., integrated circuits) (not shown), and at least two physical network interfaces which may provide connections (i.e., links) to other devices (e.g., computing devices, other network devices, etc.). In one or more embodiments, a network device also includes any number of additional components (not shown) such as, for example, network chips, field programmable gate arrays (FPGAs), application specific integrated circuits (ASICs), indicator lights (not shown), fans (not shown), etc. A network device may include any other components without departing from the invention. Examples of a network device include, but are not limited to, a network switch, router, multilayer switch, fibre channel device, an InfiniBand® device, etc. A network device is not limited to the aforementioned specific examples.

In one or more embodiments, network devices are configured to participate in one or more network protocols, which may include discovery schemes and data protection events such as the methods described in FIGS. 2A-2C. Discovery schemes are a way to discover, prior to performing a data protection event, information about all or any of the network topology in which the network device exists. Such discovery schemes may include sharing of information between network devices and may also include providing information to other devices within the system such as, for example, data nodes (e.g., 102A-102C), backup storage (e.g., 120) and/or shared storages (e.g., 110).

In one or more embodiments of the invention, a data cluster (e.g., 100) may be implemented as one or more computing devices. A data cluster (e.g., (100)) may include any number of computing devices without departing from the invention. The data cluster (e.g., 100) may include different numbers of computing devices, quantity, and types of computer resources, and may perform different computer implemented services without departing from the invention.

In one or more embodiments of the invention, the data cluster (100) includes a plurality of data nodes (e.g., 102A-102C) which include the functionality to obtain data protection services from the data protection manager (e.g., 104) and/or the cluster manager (e.g., 110). While shown as including only three data nodes (e.g., 102A-102C), the data cluster (100) can include more or less data nodes without departing from the invention, for example a cluster (e.g., 100) could comprise of at least sixteen data nodes, at least fifty data nodes, or at least a hundred data nodes without departing from the invention. The cluster can also include shared storage including at least one cluster shared volume (CSV e.g., 120) which is active with each of the data nodes (e.g., 102A-102C) of the data cluster (100). Other types of shared storage can also or alternatively be included such as active-passive storage and local storage (e.g., 114A-114C).

In one or more embodiments of the invention, the data nodes (e.g., 102A-102B) perform workloads and provide services to clients and/or other entities not shown in the system illustrated in FIG. 1. The data nodes (e.g., 102A-102C) may further include the functionality to perform computer implemented services for users (e.g., clients, not shown) of the data cluster (100). The computer implemented services may include, for example, database services, electronic mail services, data processing services, etc. The computer implemented services may include other and/or additional types of services without departing from the invention.

During the performance of the aforementioned services, data may be generated and/or otherwise obtained. The data nodes (e.g., 102A-102C) include local storage (e.g., 114A-114C) which may include multiple volumes, as well as shared storage which may include cluster shared volumes (e.g., 120). The various data storage volumes (e.g., 114A-114C as well as CSV 120) perform data storage services including storing, modifying, obtaining, and/or deleting data stored on the shared storages (e.g., 120). The data storage services may include other and/or additional services without departing from the invention. The data generated and stored on the shared storages (e.g., 114A-114C as well as CSV 120) by the data nodes (e.g., 102A-102C) may be valuable to users of the system and therefore may be protected. The data nodes (e.g., 102A-102C) may obtain backup storage services from the backup storage (106). Alternatively, the data nodes (e.g., 102A-102C) may provide backup storage services themselves and include backup storage on the local storage (e.g., 114A-114C) or the cluster shared volumes (e.g., 120). The backup storage services may include storing backups of data stored on the shared storages for restoration purposes. The backup storage services may include other and/or additional services without departing from the invention.

The data nodes (e.g., 102A-102C) may include the functionality to perform data protection services for data stored in the various data storage volumes (e.g., 114A-114C as well as CSV 120). The data protection services may include generating backups of data stored in the shared storages (106) and storing the backups in the backup storage (106). The data nodes (e.g., 102A-102C) may include the functionality to perform other and/or additional services without departing from the invention.

The data nodes (e.g., 102A-102C) may include a primary data node (e.g., 102A) and secondary data nodes (e.g., 102B and 102C). The specific configuration of which data node is the primary data node and which data node is the secondary data node can be preconfigured or automatically managed by the cluster manager (e.g., 110). The data nodes (e.g., 102A-102C) may include any number of secondary data nodes without departing from the invention. Alternatively, all data nodes (e.g., 102A-102C) may be secondary data nodes with the cluster manager (e.g., 110) performing the additional tasks of the primary node.

The data nodes (e.g., 102A-102C), may be operably connected to one or more cluster shared storages (e.g., 120) and may obtain data storage services from the one or more cluster shared storages (e.g., 120). The data nodes (e.g., 102A-102C) may be operably connected to each other and each data node (e.g., 102A) may include the ability to use all or part of the volumes, including shared active-passive drives that form the local storage (e.g., 114A-114C) of the other data nodes (e.g., 102B and 102C).

In one or more embodiments of the invention, the data nodes (e.g., 102A-102C) are implemented as computing devices (see e.g., FIG. 3). A computing device may be, for example, a mobile phone, tablet computer, laptop computer, desktop computer, server, distributed computing system, or cloud resource. The computing device may include one or more processors, memory (e.g., random access memory), and persistent storage (e.g., disk drives, solid state drives, etc.). The computing device may include instructions stored on the persistent storage so that when executed by the processor(s) of the computing device it causes the computing device to perform the functionality of the data nodes (e.g., 102A-102C) as described throughout this application.

In one or more embodiments of the invention, the data nodes (e.g., 102A-102C) are implemented as a logical device. The logical device may utilize the computing resources of any number of computing devices and thereby provide the functionality of the data nodes (e.g., 102A-102C) as described throughout this application.

In one or more embodiments of the invention, the data nodes (e.g., 102A-102C) include local storage (e.g., 114A-114C) which are only associated with only their assigned data node. The storage also includes shared storage such as a CSV (e.g., 120). The storage can also include other types of shared volumes including active-passive shared volumes which only provide data storage services to the data nodes they are active on.

The data nodes (e.g., 102A-102C) as well as other components of the cluster and connected devices may perform data storage services. The data storage services may include storing, modifying, obtaining, and/or deleting data stored on the local and shared storages (e.g., 114A-114C and 120) based on instructions and/or data obtained from the data nodes (e.g., 102A-102C) or other components of the cluster (e.g., 100). The data storage services may include other and/or additional services without departing from the invention. The local and shared storages (e.g., 114A-114C and 120) may include any number of storage volumes without departing from the invention.

The local and shared storages (e.g., 114A-114C and 120) may include storage devices (not shown) for storing data. The storage devices may be physical storage devices and/or logical storage devices. The physical storage devices may include any combination of hard disk drives, solid state disk drives, tape drives, and/or any other physical storage mediums for the storage of data.

The logical storage devices (e.g., virtualized storage) may utilize any quantity of hardware storage resources of any number of computing devices for storing data. For example, the local and shared storages (e.g., 114A-114C and 120) may utilize portions of any combination of hard disk drives, solid state disk drives, tape drives, and/or any other physical storage medium of any number of computing devices.

In one or more embodiments of the invention, the local and shared storages (e.g., 114A-114C and 120) are implemented as computing devices (see e.g., FIG. 3). A computing device may be, for example, a mobile phone, tablet computer, laptop computer, desktop computer, server, distributed computing system, or cloud resource. The computing device may include one or more processors, memory (e.g., random access memory), and persistent storage (e.g., disk drives, solid state drives, etc.). The computing device may include instructions, stored on the persistent storage, so that when executed by the processor(s) of the computing device it causes the computing device to perform the functionality of the local and shared storages (e.g., 114A-114C and 120) as described throughout this application.

In one or more embodiments of the invention, the data nodes (e.g., 102A-102C) as well as the associated local and shared storages (e.g., 114A-114C and 120) are managed by a cluster manager (e.g., 110). The cluster manager (110) performs a plurality of functions not limited to managing and configuring services provided by the data nodes (e.g., 102A-102C), managing the mapping and movement of data on at least the shared volumes, including any cluster shared volumes (e.g., 120). The cluster manager (110) can perform other functions attributed to other components of the system or function not described herein without departing from the invention.

In one or more embodiments of the invention the cluster manager (110) includes the functionality to perform a portion, or all of, the data protection services of the data protection manager (104). This may include performing discovery of the volumes and assets associated with the data nodes (e.g., 102A-102C) including those stored on the local storage (e.g., 114A-114C) and the CSV (e.g., 120). This may also include performing or initiating backups and restorations as well as determining a preferred data node including some or all of the functions described above as being ascribed to a data protection manager (e.g., 104) as well as the functions and method described in the method shown in FIG. 2A-2C and described below. The cluster manager (110) may include the functionality to perform and or obtain other and/or additional services without departing from the invention.

In one or more embodiments of the invention, the cluster manager (110) may perform discovery on the volumes and assets of the volumes and the data nodes (e.g., 102A-102C) including those stored on the local storage (e.g., 114A-114C) and the CSV (e.g., 120). The cluster manager queries each data node (e.g., 102A-102C) and their associated local and shared storage (e.g., 114A-114C and 120). Using the results of the query, the cluster manager (110) produces an asset mapping which is stored on each of the data nodes (e.g., 102A-102C). This allows for each of the data nodes (e.g., 102A-102C) to know where a given asset is located at any given time. By updating the discovery periodically, such as, but not limited by, every fifteen seconds, the asset mapping (e.g., 128) can remain accurate and provide quicker access times with less or no inter-node messaging. Further, if one data node fails, the location of at least the shared assets is not lost.

In one or more embodiments of the invention, the cluster manager (110) may in additional to or instead of the data protection manager (e.g., 104), determine the preferred data node for performing of data protection such as a backup on a given asset such as a specific application and its data and/or an entire volume. An example of the method for determining the preferred data node is shown in FIG. 2C. This may be done during the periodic discovery described above, as a result of a data protection event as shown in FIG. 2B, or at any other configured time as configured by a user, administrator, or system designer/manufacturer.

In one or more embodiments of the invention, the cluster manager (e.g., 110, FIG. 1) is a physical device. The physical device may include circuitry. The physical device may be, for example, a field-programmable gate array, application specific integrated circuit, programmable processor, microcontroller, digital signal processor, or other hardware processor. The physical device may be adapted to provide the functionality of the cluster manager (e.g., 110, FIG. 1) as described throughout this application.

In one or more embodiments of the invention, the cluster manager (e.g., 110, FIG. 1) is implemented as computer instructions, e.g., computer code, stored on a persistent storage that when executed by a processor of the cluster (e.g., 100, FIG. 1) including any-one-of the data nodes (e.g., 102A-102C, FIG. 1) to provide the functionality of the cluster manager (e.g., 110, FIG. 1) as described throughout this application.

In one or more embodiments of the invention, the cluster manager (e.g., 110, FIG. 1) is implemented as a computing device (see e.g., FIG. 3). A computing device may be, for example, a mobile phone, tablet computer, laptop computer, desktop computer, server, distributed computing system, or cloud resource. The computing device may include one or more processors, memory (e.g., random access memory), and persistent storage (e.g., disk drives, solid state drives, etc.). The computing device may include instructions stored on the persistent storage, that when executed by the processor(s) of the computing device it causes the computing device to perform the functionality of a cluster manager (e.g., 110, FIG. 1) as described throughout this application.

In one or more embodiments of the invention, the cluster manager (e.g., 110, FIG. 1) is implemented as a logical device. The logical device may utilize the computing resources of any number of computing devices and thereby provide the functionality of the backup storage (e.g., 120, FIG. 1) as described throughout this application.

In one or more other embodiments of the invention, one or more of the functions of the cluster manager (e.g., 110, FIG. 1) may be performed by a data protection manager (e.g., 104, FIG. 1), backup storage (e.g., 106, FIG. 1), individual data nodes (e.g., 102A-102C, FIG. 1), or other component of the system without departing from the invention.

FIG. 2A shows a flowchart of a method for performing a protection event. The method may be performed by, for example, a data protection manager (e.g., 104, FIG. 1), cluster manager (e.g., 110, FIG. 1), and/or data node (e.g., 102A-102C, FIG. 1). Other components of the system illustrated in FIG. 1 may perform all, or a portion, of the method of FIG. 2A without departing from the invention.

While FIG. 2A is illustrated as a series of steps, any of the steps may be omitted, performed in a different order, include additional steps, and/or perform any or all of the steps in a parallel and/or partially overlapping manner without departing from the invention.

In step 200, a data protection event is initialized. In one or more embodiments of the invention this may be initialized based on an automatic policy or by a user/administrator's request. In accordance with one or more other embodiments of the invention the data protection event may initialize automatically when one or more data nodes have a failover event. Other means for initializing a protection event discovery event associated with a data cluster can be used without departing from the invention.

During the initialization of the data protection event, a user, administrator, or a component of the system such as the data protection manager (e.g., 104, FIG. 1) determines which assets are to be protected by the data protection event. The selected assets may be one or more selected applications (including the file system itself) that are associated with one or more data nodes (e.g., 102A-102C, FIG. 1). Alternatively, the selected assets may be one or more volumes (e.g., 114A-114C and 120, FIG. 1) associated with the data nodes (e.g., 102A-102C, FIG. 1) or any combination of applications and volumes. Other aspects of the system may be selected for backup without departing from the invention.

If not previously performed or needing updating, once the data protection event is initialized, discovery is performed in step 202. In accordance with one or more embodiments of the invention, discovery (e.g., step 202) is performed at least prior to the performance of one or more data protection events. Discovery, in accordance with one or more embodiments of the invention, may also or alternatively be performed periodically such as every five minutes or other predetermined period of time, and may be performed prior or outside of the method of FIG. 2A. Its location after step 200 is only exemplary and, in accordance with one or more embodiments of the invention, discovery may be performed at any time that the data protection policies and/or user/administrator preferences configured the discovery to take place.

Discovery may map all of the assets of a cluster (e.g., 100, FIG. 1) or subset of the assets, including at least the selected assets. The mapping may be stored in each of the data nodes (e.g., 102A-102C, FIG. 1), the CSV (e.g., 120, FIG. 1), cluster manager (e.g., 110, FIG. 1), data protection manager (e.g., 104, FIG. 1), backup storage (e.g., 106, FIG. 1) or other predetermined component/storage of the cluster (e.g., 100, FIG. 1) and related system.

In accordance with one or more embodiments of the invention, during discovery (e.g., step 202 of FIG. 2A), a preferred data node can be selected for performance of a data protection event. An exemplary method for deterring the preferred data node is shown in FIG. 2C as described below. Other methods of determining a preferred data node can be used without departing from the invention. Further, the preferred data node can be determined prior to or during other steps of the method of FIG. 2A.

Turning back to the method of FIG. 2A, once the data protection event is initialized in step 200 and in accordance with one or more embodiments of the invention, discovery is performed in step 202, the method proceeds to step 204. In step 204 a determination is made if the protection event is a backup and/or a restoration of the selected assets. If the event includes a backup, the method proceeds to step 206, alternatively if the event only includes a restoration of selected assets, the method proceeds to step 210.

While step 204 only describes determining between backup and restoration events, other data protection events following similar steps to either the backup or restoration steps, can be performed instead or in addition, without departing from the invention. Such other events can include snapshots, archiving, migrating, and other data protection events.

In step 206, in accordance with one or more embodiments of the invention, a backup is performed by a data node, such as a preferred data node that is determined as discussed above during discovery, using the asset mapping produced during discovery (e.g., step 202). Alternatively, the mapping used for performing the backup in step 206 can be produced by other means. Once the backup is performed in step 206, the method proceeds to step 208.

In step 208, in accordance with one or more embodiments of the invention, it can be determined if the protection policy event also includes performing a restoration. If a restoration is also to be performed the method proceeds to step 210. If a restoration is not to be performed, in one or more embodiments of the invention, the method ends following step 208.

If the data protection event is determined in step 204 or 208 to also or alternatively, include performing a restoration, the method proceeds to step 210. In step 210, a restoration is performed using a preferred data node. The method for performing the restoration is described in more detail below with regards to the method shown in FIG. 2B. Other methods of performing the restoration can be used besides that discussed below with regards to FIG. 2B. Once the restoration is completed the method ends following step 210 (or step 208 as discussed in the previous paragraph).

FIG. 2B shows a flowchart of a method for performing a restoration using a preferred data node. The method may be performed during or after a data protection event is initiated as described above with regards to the method of FIG. 2A, the method may be performed at any time that a restoration of an asset using a preferred data node is needed. The method may be performed by, for example, a data protection manager (e.g., 104, FIG. 1) or a cluster manager (e.g., 110, FIG. 1). Other components of the system illustrated in FIG. 1 may perform all, or a portion, of the method of FIG. 2B without departing from the invention.

While FIG. 2B is illustrated as a series of steps, any of the steps may be omitted or performed in a different order including additional steps, and/or perform any or all of the steps in a parallel and/or partially overlapping manner without departing from the invention.

In step 220, in accordance with one or more embodiments of the invention, a restoration is initiated. The restoration may be from or for a specific backup that was backed up in accordance to at least step 206 of the method of FIG. 2A. Alternatively, the restoration may be for a specific asset that has been chosen by a user, administrator, data protection manager (e.g., 104, FIG. 1), data node (e.g., 102A-102C, FIG. 1) or other component of the system of FIG. 1. The asset can take the form of one or more applications and their related data, file, folder, or may comprise of restoring entire volumes, hosts, or other assets of the system. If the selected asset or backup is not associated with shared storage such as the CSV (e.g., 120, FIG. 1), then the telemetry from the data node associated with the asset to be restored is obtained and that data node performs the restoration.

If, however, the selected asset or backup is associated with shared storage such as the CSV (e.g., 120, FIG. 1), once the restoration is initiated in step 220, the method proceeds to step 222 where telemetry is received from all the active nodes. The telemetry can include such data as current usage or load of each of the data nodes, the capabilities of each of the nodes to perform different types of restoration (e.g., FBB/BBB) and/or the current workload of each of the nodes. Other information may be obtained from the telemetry without departing from the invention.

Once the telemetry is obtained from the active data nodes in step 222, in accordance with one or more embodiments of the invention, a preferred data node is determined for performing the restoration in step 224. In accordance with one or more embodiments of the invention the preferred data node is then determined based on the method discussed below with regards to the method shown in FIG. 2C. Other methods for obtaining the preferred data node can be used without departing from the invention.

After the preferred data node is determined in step 224, the method proceeds to step 226. In one or more embodiments of the invention, step 226, comprises of performing restoration using the preferred node. This may comprise of restoring one or more applications and their related data, file, folder, or may comprise of restoring entire volumes, hosts, or other assets of the system. The restoration, in accordance with one or more embodiments of the invention, may occur in the local storage (e.g., 114A-114C, FIG. 1) of the data node (e.g., 102A-102C, FIG. 1), or may be a restoration to shared storage such as the CSV (e.g., 120, FIG. 1). Alternatively, the restoration can occur in any connected computing device, which was determined when the restoration was initiated.

In one or more embodiments of the invention, the method ends following step 226.

FIG. 2C shows a flowchart of a method for determining a preferred node for performing a restoration of selected assets in accordance with one or more embodiments of the invention. In one or more embodiments of the invention the method may also be used for determining a preferred node to perform a backup of a selected asset. The method may be performed in accordance with one or more embodiments of the invention by a data protection manager (e.g., 104, FIG. 1). Other components of the system, such as the cluster manager (e.g., 110, FIG. 1), may perform all or a portion of the method of FIG. 2C without departing from the invention.

While FIG. 2C is illustrated as a series of steps, any of the steps may be omitted, performed in a different order, include additional steps, and/or perform any or all of the steps in a parallel and/or partially overlapping manner without departing from the invention.

In step 230, in accordance with one or more embodiments of the invention, the method determines if a user or administrator of the system (such as the cluster (e.g., 100, FIG. 1)) has determined a preferred data node. This may have been done at the time the restoration or other data protection event was initialized or when a user or administrator configured the data protection policies and or the system in general. The determination may be performed by a data protection manager (e.g., 104, FIG. 1), a data node (e.g., 102A-102B, FIG. 1), a backup storage (e.g., 106, FIG. 1), and/or a cluster manager (e.g., 110, FIG. 1) Other components of the system and/or cluster (e.g., 100, FIG. 1) may determine if the user or administrator has selected a preferred node without departing from the invention.

Once the determination is made in step 230, the method proceeds to step 232 and if a user did select a preferred node, the method proceeds to step 244, where the preferred node selected by the user or administrator is returned to step 224 of the method of FIG. 2B and the method of FIG. 2C ends. If, however, in step 232 it is determined that the user or administrator has not selected a preferred node, the method proceeds to step 234.

In step 234, the telemetry that was gathered in step 222 of FIG. 2B, is used to determine the current load and workload of each data node (e.g., 102A-102C, FIG. 1). Other aspects of each data node (e.g., 102A-102C, FIG. 1) can also be determined without departing from the invention.

The method then proceeds to step 236, where the original backup, from which a selected asset is to be restored from is analyzed. This can be to determine the original data node which the backup was performed from and/or the type of backup that was performed, such as, but not limited to, a full, incremental, block-based backup (BBB), or file-based backup (FBB). Each backup type has different requirements and requires different number of resources when the backup is restored.

Once the method determines in step 236 and 234 the current loads, workload, and type of backup, based on predetermined criteria, the method selects a preferred data node for performing the restoration or other data protection event. The predetermined criteria, in accordance with one or more embodiments of the invention, may be that the original data node that performed the original backup is still available and has a load that is less than a predetermined amount. Alternatively, the predetermined criteria may look for the data node (e.g., 102A-102C) that has the lowest load compared to other data nodes. If it is found that two or more data nodes (e.g., 102A and 102C) have the same load, the method may then determine which has fewer active hosts or current workload. Also, or alternatively, in accordance with one or more embodiments of the invention, a specific data node may be the preferred data node for performing restorations from BBB type backups while another is preferred for FBB type backups. Other combinations and/or predetermined criteria may be used for determining the preferred data node in step 238.

In one or more embodiments of the invention, the method ends following step 244 and the determined preferred data node is returned to step 224 of FIG. 2B or other step of any method for performing a data protection event with a preferred data node.

As discussed above, embodiments of the invention may be implemented using computing devices. FIG. 3 shows a diagram of a computing device in accordance with one or more embodiments of the invention. The computing device (300) may include one or more computer processors (302), non-persistent storage (304) (e.g., volatile memory, such as random access memory (RAM), cache memory), persistent storage (306) (e.g., a hard disk, an optical drive such as a compact disk (CD) drive or digital versatile disk (DVD) drive, a flash memory, etc.), a communication interface (312) (e.g., Bluetooth® interface, infrared interface, network interface, optical interface, etc.), input devices (310), output devices (308), and numerous other elements (not shown) and functionalities. Each of these components is described below.

In one embodiment of the invention, the computer processor(s) (302) may be an integrated circuit for processing instructions. For example, the computer processor(s) may be one or more cores or micro-cores of a processor. The computing device (300) may also include one or more input devices (310), such as a touchscreen, keyboard, mouse, microphone, touchpad, electronic pen, or any other type of input device. Further, the communication interface (312) may include an integrated circuit for connecting the computing device (300) to a network (not shown) (e.g., a local area network (LAN), a wide area network (WAN) such as the Internet, mobile network, or any other type of network) and/or to another device, such as another computing device.

In one embodiment of the invention, the computing device (300) may include one or more output devices (308), such as a screen (e.g., a liquid crystal display (LCD), plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (302), non-persistent storage (304), and persistent storage (306). Many diverse types of computing devices exist, and the aforementioned input and output device(s) may take other forms.

One or more embodiments of the invention may be implemented using instructions executed by one or more processors of the cluster manager. Further, such instructions may correspond to computer readable instructions that are stored on one or more non-transitory computer readable mediums.

One or more embodiments of the invention may improve the operation of one or more computing devices in a cluster environment. Specifically, embodiments of the invention relate to a method of performing a restoration of at least one selected asset located in the data cluster.

One or more embodiments of the invention relates to a method of performing a restore, by either allowing a user or administrator to choose a preferred data node for performing a restoration, or by having a data protection manager or similar component of a system dynamically choses a preferred data node for performing a restoration based on predetermined criteria. Such predetermined criteria may include each data node's load, workload, as well as the type of backup that was performed to make the backup of the at least one selected asset. This will allow for more efficient restoration, while avoiding overloading when restoring assets from a backup in a data cluster.

The problems discussed above should be understood as being examples of problems solved by embodiments of the invention disclosed herein and the invention should not be limited to solving the same/similar problems. The disclosed invention is broadly applicable to address a range of problems beyond those discussed herein.

While the invention has been described with respect to a limited number of embodiments, those skilled in the art, having benefit of this disclosure, will appreciate that other embodiments can be devised which do not depart from the scope of the technology as disclosed herein. Accordingly, the scope of the invention should be limited only by the attached claims.

What is claimed is:

1. A method for performing a restoration of at least one asset from a backup of the at least one asset in a cluster environment comprising of a plurality of data nodes, the method comprising:
initiating, by a data protection manager, the restoration of the at least one asset from the backup;
determining, using restoration criteria, by the data protection manager, a preferred data node; and
signaling by the data protection manager, the preferred data node to perform the restoration of the at least one asset.

2. The method of claim 1, wherein determining, using the restoration criteria, by the data protection manager, the preferred data node, comprises using a user configuration.

3. The method of claim 1, wherein determining, using the restoration criteria, by the data protection manager, the preferred data node, comprises using telemetry from each of the plurality of data nodes to determine a load on each of the plurality of data nodes, wherein the preferred data node has a lowest load.

4. The method of claim 1, wherein determining, using the restoration criteria, by the data protection manager, the preferred data node, comprises using backup type, wherein the backup type is one selected from a file-based backup and a block-based backup.

5. The method of claim 1, wherein the preferred data node is not a data node of the plurality of data nodes from which the at least one asset was originally backed up.

6. The method of claim 1, wherein determining, using the restoration criteria, by the data protection manager, the preferred data node comprises using telemetry from each of the plurality of data nodes to identify a data of the plurality of data nodes on which the restoration will have the least impact on its current workload.

7. The method of claim 1, wherein the least at one asset is a shared volume.

8. A system comprising:
a plurality of data nodes; and
a data protection manager which comprises of:
at least one processor;
at least one storage device; and
at least one memory that includes instructions, which when executed by the processor, performs a method for performing a restoration of at least one asset from a backup of the at least one asset in a cluster environment comprising of the plurality of data nodes, the method comprising:
initiating, by the data protection manager, the restoration of the at least one asset from the backup;
determining, using restoration criteria, by the data protection manager, a preferred data node;
signaling by the data protection manager, the preferred data node to perform the restoration of the at least one asset.

9. The system of claim 8, wherein determining, using the restoration criteria, by the data protection manager, the preferred data node, comprises using a user configuration.

10. The system of claim 8, wherein determining, using the restoration criteria, by the data protection manager, the preferred data node, comprises using telemetry from each of the plurality of data nodes to determine a load on each of the plurality of data nodes, wherein the preferred data node has a lowest load.

11. The system of claim 8, wherein determining, using the restoration criteria, by the data protection manager, the preferred data node, comprises using backup type, wherein the backup type is one selected from a file-based backup and a block-based backup.

12. The system of claim 8, wherein the preferred data node is not a data node of the plurality of data nodes from which the at least one asset was originally backed up.

13. The system of claim 8, wherein determining, using the restoration criteria, by the data protection manager, the preferred data node comprises using telemetry from each of the plurality of data nodes to identify a data of the plurality of data nodes on which the restoration will have the least impact on its current workload.

14. The system of claim 8, wherein the least at one asset is a shared volume.

15. A non-transitory computer readable medium comprising computer readable program code, which when executed by a computer processor enables the computer processor to perform a method for performing a restoration of at least one asset from a backup of the at least one asset in a cluster environment comprising of a plurality of data nodes, the method comprising:
initiating, by a data protection manager, the restoration of the at least one asset from the backup;
determining, using restoration criteria, by the data protection manager, a preferred data node; and
signaling by the data protection manager, the preferred data node to perform the restoration of the at least one asset, wherein the at least one asset is a shared volume.

16. The non-transitory computer readable medium of claim 15, wherein determining, using the restoration criteria, by the data protection manager, the preferred data node, comprises using a user configuration.

17. The non-transitory computer readable medium of claim 15, wherein determining, using the restoration criteria, by the data protection manager, the preferred data node, comprises using telemetry from each of the plurality of data nodes to determine a load on each of the plurality of data nodes, wherein the preferred data node has a lowest load.

18. The non-transitory computer readable medium of claim 15, wherein determining, using the restoration criteria, by the data protection manager, the preferred data node, comprises using backup type, wherein the backup type is one selected from a file-based backup and a block-based backup.

19. The non-transitory computer readable medium of claim 15, wherein the preferred data node is not a data node of the plurality of data nodes from which the at least one asset was originally backed up.

20. The non-transitory computer readable medium of claim 15, wherein determining, using the restoration criteria, by the data protection manager, the preferred data node comprises using telemetry from each of the plurality of data nodes to identify a data of the plurality of data nodes on which the restoration will have the least impact on its current workload.
